(19) United States
(12) Patent Application Publication
(10) Pub. No.: US 2011/0264688 A1
(43) Pub. Date: Oct. 27, 2011

(54) PEER TO PEER (P2P) DATA LICENSING MODEL IN A DISTRIBUTED ABSTRACT QUERY ENVIRONMENT

(75) Inventors: Richard D. Dettinger, Rochester, MN (US); Frederick A. Kulack, Rochester, MN (US); Kevin G. Paterson, San Antonio, TX (US); Shannon E. Wenzel, Colby, WI (US)

(73) Assignee: INTERNATIONAL BUSINESS MACHINES CORPORATION, Armonk, NY (US)

(21) Appl. No.: 12/767,442

(22) Filed: Apr. 26, 2010

(51) Int. Cl. G06F 17/30; G06F 15/16; G06F 3/048

(52) U.S. Cl. 707/769; 707/E17.014; 707/784; 707/E17.005; 715/810

(57) ABSTRACT

Methods, systems, and articles of manufacture for retrieving results for a query. One or more peer devices in a peer to peer network may define licensing terms for accessing data in one or more respective subsets of data contained therein. Upon receiving a query, the results of the data in data sets having licensing terms may be displayed to a requesting entity only upon acquiring an appropriate license.

### BACKGROUND

1. Field

The present invention is generally related to data processing, and more specifically to retrieving data from a database.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find the location of data, and so forth.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

### SUMMARY OF THE INVENTION

The present invention is generally related to data processing, and more specifically to retrieving data from a database.

One embodiment provides a method for providing results for a query, including defining at least one licensing term for accessing at least a first field defined by a data abstraction model comprising a plurality of logical field definitions mapped to physical fields of a database; receiving an abstract query from a requesting entity, wherein the abstract query comprises one or more logical fields defined by the data abstraction model, the one or more logical fields of the query comprising the first field; retrieving results for the abstract query; determining whether the requesting entity has acquired a license to access the first field based on the licensing term; and upon determining that the requesting entity has not acquired a license to access the first field, providing the retrieved results to the requesting entity, wherein data in the first field is concealed from the requesting entity.

Another embodiment provides a computer readable storage medium comprising a program product which, when executed, is configured to perform operations for providing results for a query. The operations include: defining at least one licensing term for accessing at least a first field defined by a data abstraction model comprising a plurality of logical field definitions mapped to physical fields of a database; receiving an abstract query from a requesting entity, wherein the abstract query comprises one or more logical fields defined by the data abstraction model, the one or more logical fields of the query comprising the first field; retrieving results for the abstract query; determining whether the requesting entity has acquired a license to access the first field based on the licensing term; and upon determining that the requesting entity has not acquired a license to access the first field, providing the retrieved results to the requesting entity, wherein data in the first field is concealed from the requesting entity.

Another embodiment provides a system, including at least a first device and a second device, wherein the first device comprises a data abstraction model comprising a plurality of logical field definitions mapped to physical fields of a database. The first device is configured to: define at least one licensing term for accessing at least a first field defined by the data abstraction model; receive an abstract query from the second device, wherein the abstract query comprises one or more logical fields defined by the data abstraction model, the one or more logical fields of the query comprising the first field; retrieve results for the abstract query; determine whether the requesting entity has acquired a license to access the first field based on the licensing term; and upon determining that the requesting entity has not acquired a license to access the first field, provide the retrieved results to the requesting entity, wherein data in the first field is concealed from the requesting entity.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates a more detailed view of an exemplary client computer and server, according to an embodiment of the invention.

FIG. 3 illustrates an exemplary relational view 300 of system components according to an embodiment of the invention.

FIG. 4 illustrates a data abstraction model according to an embodiment of the invention.

FIG. 5 illustrates query execution in an exemplary system according to an embodiment of the invention.

FIG. 6 illustrates query execution in another exemplary system according to an embodiment of the invention.

FIG. 7 is a flow diagram of exemplary operations performed by a query manager according to an embodiment of the invention.

FIG. 8 is another flow diagram of exemplary operations performed by a query manager according to an embodiment of the invention.

FIG. 9 illustrates an exemplary graphical user interface for defining licensing terms according to an embodiment of the invention.

FIG. 10 illustrates an exemplary hierarchy of logical fields, according to an embodiment of the invention.

FIG. 11 illustrates another exemplary graphical user interface for defining licensing terms according to an embodiment of the invention.

FIG. 12 illustrates an exemplary graphical user interface for displaying query results according to an embodiment of the invention.

### DETAILED DESCRIPTION OF THE PREFERRED EMBODIMENTS

The present invention is generally related to data processing, and more specifically to retrieving data from a database. One or more peer devices in a peer to peer network may define licensing terms for accessing data in one or more respective subsets of data contained therein. Upon receiving a query, the results of the data in data sets having licensing terms may be displayed to a requesting entity only upon acquiring an appropriate license.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

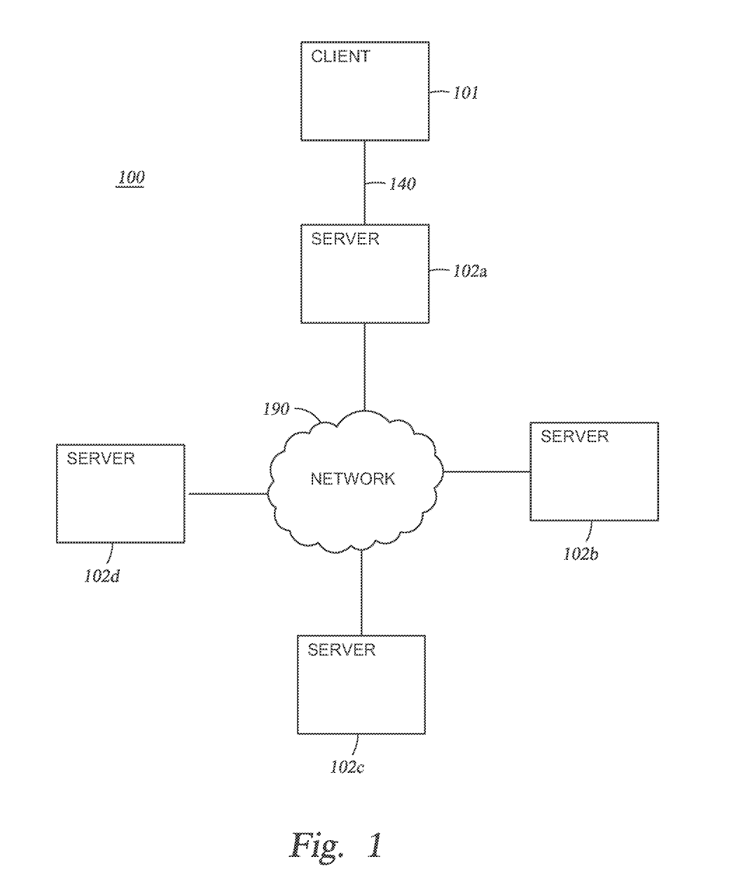

FIG. 1 depicts a block diagram of a networked system 100 in which embodiments of the invention may be implemented. In general, the networked system 100 includes at least one client (e.g., user's) computer 101 and a plurality of servers 102 (four such servers 102a-d shown). The client computer 101 may be coupled with a server 102 (server 102a in FIG. 1) via a network 140. In general, the network 140 may be a local area network (LAN) and/or a wide area network (WAN). In a particular embodiment, the network 140 is the Internet. In one embodiment, the client computer 101 may be configured to issue queries against the server 102a and retrieve data from the server 102a, as will be described in greater detail below.

Each of the servers 102 may be coupled with each other via a network 190. Like network 140, network 190 may also be any one of 140 may be any one or a local area network (LAN), a wide area network (WAN), and/or the Internet. In a particular embodiment of the invention the network 190 may be a peer-to-peer network. A peer-to-peer network is defined herein as any network comprising two or more interconnected devices that are configured to share their respective data, resources, and the like. The devices associated with network 190 may be coupled in any reasonable manner, whether known or unknown, to form any type of P2P network. Exemplary P2P network types include centralized P2P network, decentralized P2P network, structured P2P network, unstructured P2P network, hybrid P2P network, and the like.

Regardless of the type of P2P network 190, generally, any server 102 connected to the P2P network 190 may be configured to independently collect, store, analyze and modify data. Furthermore, the data stored on any server 102 may be transferred to any other server 102 via the network 190. For example, in one embodiment, each server 102 may be configured to issue queries to one or more other servers 102 via the network 190 to retrieve desired data.

While two separate networks 140 and 190 are illustrated in FIG. 1, in alternative embodiments, client computers 101 and the servers 102 may be coupled to the same network, for example, the Internet.

In one embodiment of the invention, in response to receiving a query from the client computer 101, server 102a may be configured to retrieve query results that are stored therein. The server 102a may also be configured to transfer the query to one or more other servers 102 via the network 190, retrieve further query results stored in the one or more other server 102, and provide the query results to the client computer 101. Retrieving query results from one or more servers 102 coupled with the P2P network 190 is described in greater detail below.

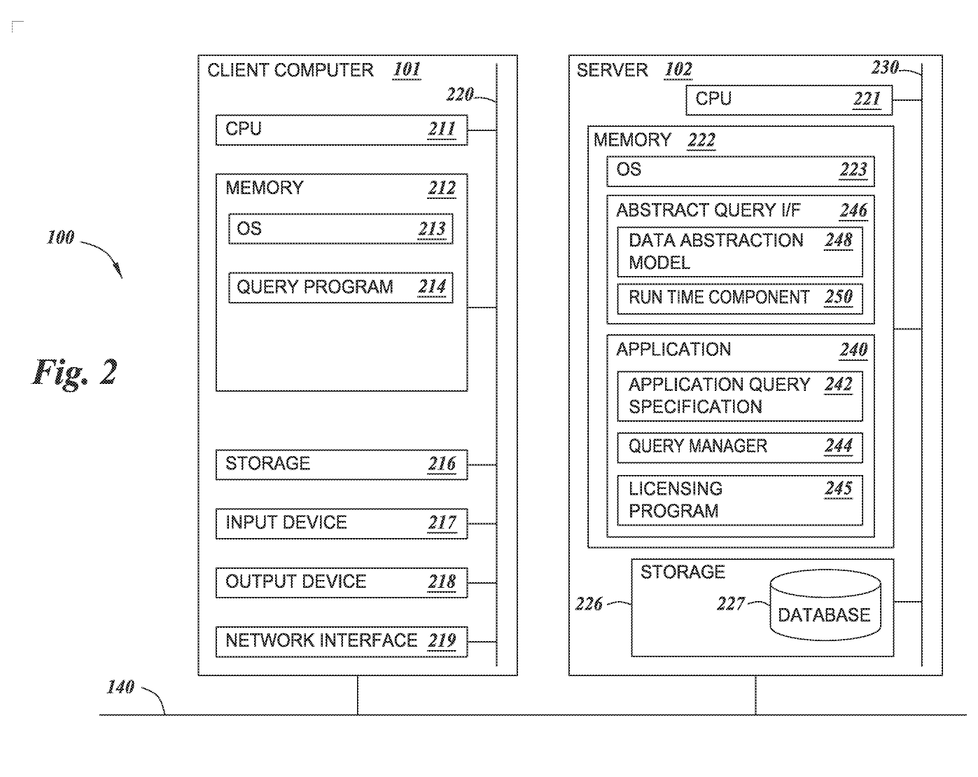

FIG. 2 illustrates a more detailed view of an exemplary client computer 101 and a server 102, according to an embodiment of the invention. The server 102 may be any one of servers 102a-d depicted in FIG. 1. The client computer 101 may include a Central Processing Unit (CPU) 211 connected via a bus 220 to a memory 212, storage 216, an input device 217, an output device 218, and a network interface device 219. The input device 217 can be any device to give input to the client computer 101. For example, a keyboard, keypad, light-pen, touch-screen, track-ball, or speech recognition unit, audio/video player, and the like could be used. The output device 218 can be any device to give output to the user, e.g., any conventional display screen. Although shown separately from the input device 217, the output device 218 and input device 217 could be combined. For example, a display screen with an integrated touch-screen, a display with an integrated keyboard, or a speech recognition unit combined with a text speech converter could be used.

The network interface device 219 may be any entry/exit device configured to allow network communications between the client computers 101 and server 102 via the network 140. For example, the network interface device 219 may be a network adapter or other network interface card (NIC).

Storage 216 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 212 and storage 216 could be part of one virtual address space spanning multiple primary and secondary storage devices.

The memory 212 is preferably a random access memory sufficiently large to hold the necessary programming and data structures of the invention. While memory 212 is shown as a single entity, it should be understood that memory 212 may in fact comprise a plurality of modules, and that memory 212 may exist at multiple levels, from high speed registers and caches to lower speed but larger DRAM chips.

Illustratively, the memory 212 contains an operating system 213. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 212 is also shown containing a query program 114 which, when executed by CPU 211, provides support for issuing queries to server 102. In one embodiment, the query program 214 may include a web-based Graphical User Interface (GUI), which allows the user to display Hyper Text Markup Language (HTML) information. The GUI may be configured to allow a user to create a query, issue the query against a server 102, and display the results of the query. More generally, however, the query program may be a GUI-based program capable of rendering any information transferred between the client computer 101 and the server 102.

The server 102 may be physically arranged in a manner similar to the client computer 101. Accordingly, the server 102 is shown generally comprising a CPU 221, memory 222, and a storage device 226, coupled with one another by a bus 130. Memory 222 may be a random access memory sufficiently large to hold the necessary programming and data structures that are located on server 102.

The server 102 may generally be under the control of an operating system 223 shown residing in memory 222. Examples of the operating system 123 include IBM OS/400®, UNIX, Microsoft Windows®, Linux and the like. More generally, any operating system capable of supporting the functions described herein may be used.

The memory 222 may further include one or more applications 240 and an abstract query interface 246. The applications 240 and the abstract query interface 246 may be software products comprising a plurality of instructions that are resident at various times in various memory and storage devices in the computer system 100. When read and executed by a processor 221 in the server 102, the applications 240 and the abstract query interface 246 cause the computer system 100 to perform the steps necessary to execute steps or elements embodying the various aspects of the invention.

The applications 240 (and more generally, any requesting entity, including the operating system 223) may be configured to issue queries against a database 227 (shown in storage 226). The database 227 is representative of any collection of data regardless of the particular physical representation. By way of illustration, the database 227 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

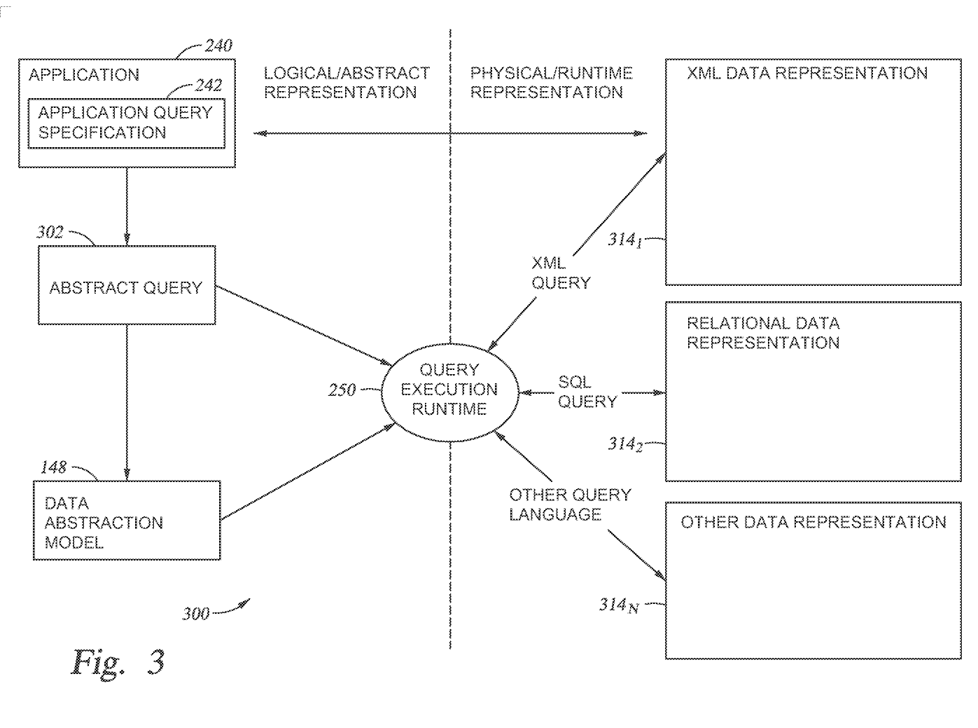

In one embodiment, the queries issued by the applications 240 are defined according to an application query specification 242 included with each application 240. The queries issued by the applications 240 may be predefined (i.e., hard coded as part of the applications 240) or may be generated in response to input (e.g., user input). In either case, the queries (referred to herein as “abstract queries”) are composed using logical fields defined by the abstract query interface 246. In particular, the logical fields used in the abstract queries are defined by a data abstraction model 248 of the abstract query interface 246. The abstract queries are executed by a runtime component 250 which transforms the abstract queries into a form consistent with the physical representation of the data contained in the database 227. The application query specification 242 and the abstract query interface 246 are further described with reference to FIG. 3.

The applications 240 may also include a query manager program 244. Query manager 244 may be configured to receive a query from a client computer 101, or an application 240, receive results for the query, and provide the query results to the requesting client computer 101 or application 240. In one embodiment of the invention retrieving query results may involve retrieving query results from the database 227, as described above. In some embodiments, the query manager 244 may be configured to transfer a received query to one or more other servers 102 via the P2P network 190, and retrieve query results from the one or more other servers 102, as will be discussed in greater detail below.

The applications 240 may also include a licensing program 245. The licensing program may be configured to generate one or more graphical user interface screens for setting one or more licensing terms for accessing data contained in the server 102. In one embodiment, the licensing program may be configured to work in conjunction with the query manager 244 to ensure that data sent from the server 102 to a client computer 101 or another server 102 is compliant with one or more predefined licensing terms. While the licensing program is shown as a separate entity, in alternative embodiments, the licensing program 245 may be a part of another application, e.g., the query manager 244. The licensing program 245 is described in greater detail below.

### Relational View of Environment

FIG. 3 illustrates an exemplary relational view 300 of components according to an embodiment of the invention. A requesting entity, for example, an application 240 may issue a query 302 as defined by the respective application query specification 242 of the requesting entity. The resulting query 302 is generally referred to herein as an “abstract query” because the query is composed according to abstract (i.e., logical) fields rather than by direct reference to the underlying physical data entities in the database 227. As a result, abstract queries may be defined that are independent of the particular underlying data representation used. In one embodiment, the application query specification 242 may include both criteria used for data selection and an explicit specification of the fields to be returned based on the selection criteria.

The logical fields specified by the application query specification 242 and used to compose the abstract query 302 may be defined by the data abstraction model 248. In general, the data abstraction model 248 may expose information as a set of logical fields that may be used within a query (e.g., the abstract query 302) issued by the application 240 to specify criteria for data selection and specify the form of result data returned from a query operation. The logical fields may be defined independently of the underlying data representation being used in the database 227, thereby allowing queries to be formed that are loosely coupled to the underlying data representation. Abstract queries are described in greater detail in co-pending U.S. patent application Ser. No. 11/226,181, entitled IMPROVED APPLICATION PORTABILITY AND EXTENSIBILITY THROUGH DATABASE SCHEMA AND QUERY ABSTRACTION, filed Sep. 14, 2005, which is incorporated herein by reference in its entirety.

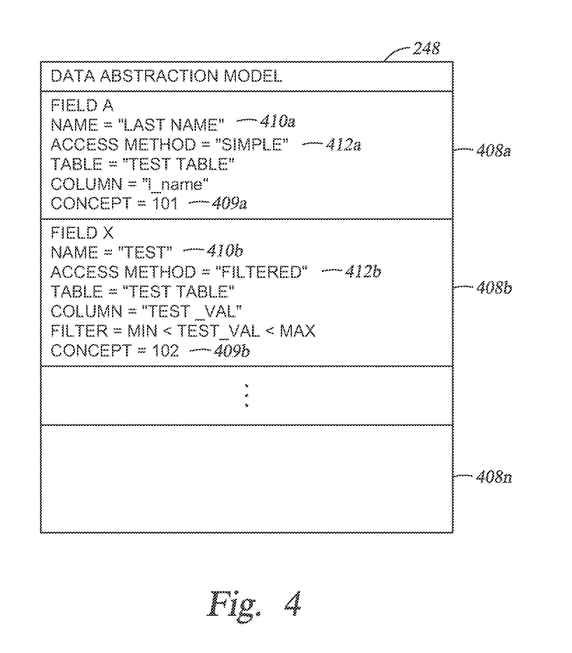

FIG. 4 illustrates an exemplary data abstraction 148 model according to an embodiment of the invention. In general, data abstraction model 148 comprises a plurality of field specifications 408. A field specification may be provided for each logical field available for composition of an abstract query. Each field specification may comprise a logical field name 410 and access method 412. For example, the field specification for Field A in FIG. 3 includes a logical field name 410a ('LastName'), and an associated access method 412a (‘simple’).

The access methods may associate logical field names 410 to a particular physical data representation 314 (See FIG. 3) in a database 227. By way of illustration, two data representations are shown in FIG. 3, an XML data representation 314₁, and a relational data representation 314₂. However, the physical data representation 314_{N} indicates that any other data representation, known or unknown, is contemplated. In one embodiment, a single data abstraction model 148 may contain field specifications with associated access methods for two or more physical data representations 314. In an alternative embodiment, a separate data abstraction model 148 may be provided for each separate data representation 314.

Any number of access method types is contemplated depending upon the number of different types of logical fields to be supported. In one embodiment, access methods for simple fields, filtered fields and composed fields are provided. For example, field specifications for Field A exemplify a simple field access method 412a. Simple fields are mapped directly to a particular entity in the underlying physical data representation (e.g., a field mapped to a given database table and column). By way of illustration, the simple field access method 412a, shown in FIG. 4 maps the logical field name 410a ('LastName') to a column named “I_name” in a table named “Test Table,” as illustrated.

The field specification for Field X exemplifies a filtered field access method 412b. Filtered fields identify an associated physical entity and provide rules used to define a particular subset of items within the physical data representation. For example, the filtered field access method 412b may map the logical field name 410b to a physical entity in a column named “TestVal” in a table named “Test Table” and may define a filter for the test values. For example, in one embodiment, the filter may define a numerical range in which the test values may be deemed valid.

A composed field access method may also be provided to compute a logical field from one or more physical fields using an expression supplied as part of the access method definition. In this way, information which does not exist in the underlying data representation may be computed. For example, a sales tax field may be composed by multiplying a sales price field by a sales tax rate.

It is contemplated that the formats for any given data type (e.g., dates, decimal numbers, etc.) of the underlying data may vary. Accordingly, in one embodiment, the field specifications 408 may include a type attribute which reflects the format of the underlying data. However, in another embodiment, the data format of the field specifications 408 is different from the associated underlying physical data, in which case an access method is responsible for returning data in the proper format assumed by the requesting entity.

Thus, the access method must know what format of data is assumed (i.e., according to the logical field) as well as the actual format of the underlying physical data. The access method may then convert the underlying physical data into the format of the logical field. By way of example, the field specifications 408 of the data abstraction model 248 shown in FIG. 3 are representative of logical fields mapped to data represented in the relational data representation 314₂. However, other instances of the data abstraction model 248 map logical fields to other physical data representations, such as XML.

Each field 408 of the data abstraction model 148 may also include a concept code 409. For example, the concept code for field 408a may be 101 as illustrated in FIG. 4. Concept code 409 may associate a respective field 408 to a predefined universal concept. For example, field 408a illustrated in FIG. 4 is associated with a column containing last names. Accordingly, field 408a is titled “Last Name” and associated with the column “I_name” in the table “Test Table”. However, the concept “last name” may have several synonyms. For example, in some systems last names may be identified as a “surnames” or “family names”. The concept code 409 may provide a means for identifying a universal concept, regardless of how it is specifically labeled in a given system. Accordingly, concept codes may also be referred to herein as “entity resolution attributes” in that these attributes are applied to resolve one local field definition (for a first data abstraction model) to another local field definition (for a second data abstraction model) on the basis of a standardized field definition.

For example, referring to FIG. 1, the data abstraction model in server 102a may have a logical field named “Last Name” and the data abstraction model in server 102b may have a logical field named “Family Name”. The concept code for the field “Last Name” in server 102a and the concept code for the field “Family Name” in server 102b may both be 101 because they both refer to the same concept.

While a numerical concept code 409 is illustrated in FIG. 4, in alternative embodiments any combination of alphabets, numbers, words, phrases, symbols, and the like may be used to define concept codes. In one embodiment of the invention, the concept code 409 may be derived from a recognized universal vocabulary, such as, for example, a standardized industry-specific vocabulary. Exemplary standardized universal vocabularies may include, among others, UMLS (Universal Medical Language System), MeSH (Medical Subject Headings), SnoMed (Systematic Nomenclature of Medicine), and the like.

Furthermore, while standardized universal vocabularies are described herein with reference to concept codes 409, in alternative embodiments, the concept codes 409 may be generated for internal use by groups of individuals and/or organizations. For example, while working on a project, one or more entities working on the project may agree upon a standardized set on concepts and respective concept codes for categorizing data. Thereafter, each entity may then generate their own respective data abstraction models to store data related to their respective project tasks in their own respective server or system. The data abstraction model generated by each entity may be different. For example, each entity may define its own logical fields in a respective data abstraction model which may be distinct from the logical fields defined by other entities. However, the concept codes used to define fields in the respective data abstraction models may be derived from the agreed upon set of concept codes.

### Retrieving Results from Multiple Peer Devices

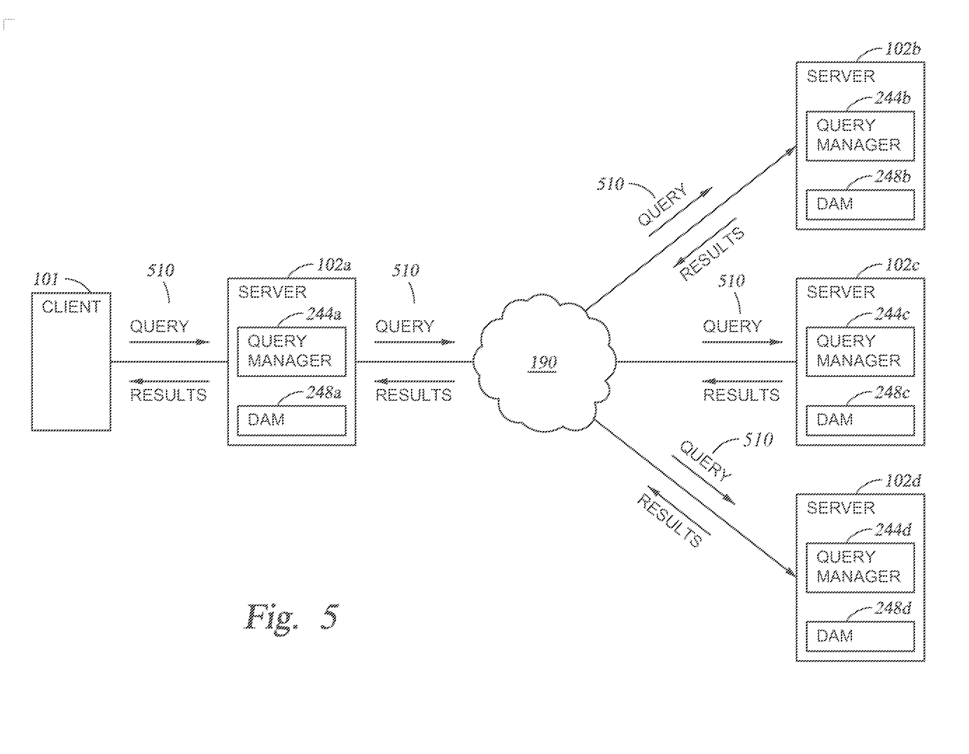

In one embodiment of the invention, the concept codes may facilitate retrieving query results from a plurality of devices in a P2P network. FIG. 5 illustrates another exemplary system 500 according to an embodiment of the invention. System 500 may be similar to system 100 illustrated in FIG. 1, and therefore may include at least one client computer 101 and a plurality of servers 102, for example, servers 102a-d coupled to each other via the P2P network 190. As illustrated in FIG. 5, each of the servers 102a-d may include a respective data abstraction model 248a-d. The data abstraction models 248a-d may define logical fields that may be used to compose abstract queries that may be issued against databases in respective servers 102a-d.

In one embodiment of the invention, the servers 102a-d may be peer devices operated by entities working on a collaborative project. For example, in a particular embodiment, each of the servers 102a-d may be associated with a respective university for storing research data. In alternative embodiments, each of the servers 102a-d may belong to a respective hospital or a department of a hospital, wherein each server 102 stores patient records, medical research data, and the like. More generally, each of the servers 102a-d may belong to one or more entities, whether individuals or organizations, that collect and store data in an independent and decentralized manner.

A decentralized approach to collecting and storing data may be advantageous because it may allow each entity to collect and store the data without being subject to each others' data collection procedures, data categorizations, analysis and the like. Therefore, the decentralized data collection and storing methods may facilitate a wide variety of entities to be seamlessly integrated into a collaborative project.

However, the independent data collection and storage may also result in difficulties while sharing data between the entities. For example, while performing research on a particular disease, a hospital or university may desire data collected by one or more other hospitals and/or universities to aid the research. However, different categorization of data in each hospital or university server may make it difficult to retrieve such data. For example, as described above, the DAM 248a may have a logical field named “Last Name” and DAM 248b may have a logical field named “Family Name”. Furthermore, the DAM 248c may have a logical field named “Surname”. Therefore, retrieving data related to last names from servers 102a-c may require separate abstract queries to be written for each of the servers 102a-c. Manually writing multiple abstract queries and combining the query results may be a tedious, inefficient and error prone process.

In one embodiment of the invention, the fields in the data abstraction models 248a-d may have similar concepts but may have varying logical field definitions. Embodiments of the invention provide an automated method for retrieving query results from a plurality of servers 102 coupled to a P2P network 109 using concept codes in response to receiving a query. For example, as illustrated in FIG. 5, an abstract query 510 may be sent from a client computer 101 to server 102a. Alternatively an application program 240 of server 102a (see FIG. 2) may generate an abstract query 510. The query 510 may be received by the query manager 244a of the server 102a. Query manager 244a may issue the abstract query 510 against a database associated with server 102a to retrieve at least some of the results of the query.

Furthermore, the query manager 244a may send the abstract query 510 to one or more of the servers 102b-d to request further results for the abstract query 510, as illustrated in FIG. 5. For example, in one embodiment, the server 102a may include a record including a list of the peer computers 102b-d. Accordingly, the query manager 244a may be configured to access the record to determine peer computers prior to sending the abstract query 510 to the peer servers 102b-d. In one embodiment, the query manager 244a may send the abstract query 510 to all known peers servers. Alternatively, in some embodiment, the query manager 244a may send the abstract query 510 to a subset of the known peers.

The abstract query 510 may be received by each of query managers 244b-d at the servers 102b-d. Each of the query managers 244b-d may convert the abstract query 510 to a local abstract query based on concept codes as will be described in greater detail below. The query managers 244b-d may issue the local abstract queries against respective databases associated with the servers 102b-d to retrieve further results for the abstract query 510.

In one embodiment, the query results from each of the servers 102b-d may be transferred to the server 102a via the P2P network 190, as illustrated in FIG. 5. The query results from each of the servers 102b-d may be received by the query manager 244a. In one embodiment, the query manager 244a may combine the results received from the servers 102b-d with the query results retrieved from the server 102a and provide the results to a requesting client 101 or application program 240. Alternatively, the query manager may be configured to average and/or normalize the set of results received from the server 102 a-d.

In some embodiments, the abstract query 510 may include one or more clauses that determine how query results are to be presented. For example, in a particular embodiment, the abstract query 510 may include a sort clause that, for example, requires that query results be presented in an ascending or descending order in relation to a particular results field. Accordingly, in some embodiments, the query manager 244a may be configured to perform one or more operations, for example, sorting, on the combined result set prior to presenting the query results to a requesting entity. In some embodiments, the query manager 244a may be configured to provide source identification data of the query results to a requesting entity. For example, the query manager 244a may be configured to identify the particular server 102a-d from which a particular query result is derived. The identification data may be displayed in an identification field that may be included in the query results.

In one embodiment of the invention, the abstract query 510 received by server 102 from a client 101 or an application program 240 of server 102a may include logical fields defined by the abstraction model 248a of server 102a. An exemplary abstract query 510 is provided below:
SELECT First Name
WHERE Last Name=“Smith”

The abstract query 510 provided above may be configured to retrieve first names of individuals whose last name is “Smith”. Illustratively, the fields “First Name” and “Last Name” may be logical fields defined by the data abstraction model 248a of server 102a.

In one embodiment of the invention, abstract query 510 may be transferred to the one or more other servers 102b-d by query manager 244a along with concept codes associated with each logical field of the abstract query 510. In one embodiment, the concept codes may be encoded into the abstract query 510. For example, the query manager 244a may transfer the concept codes for “Last Name” and “First Name” along with the abstract query 510 provided above to the one or more other servers 102b-d.

Upon receiving the abstract query 510 from server 102a, each of the one or more query managers 244b-d may be configured to convert the abstract query 510 to a local abstract query based on the concept codes associated with each logical field of abstract query 510. For example, the DAM 248b of server 102b may include the logical fields “Family Name” and “Given Name”. The concept codes associated with the logical fields “Last Name” and “First Name” of DAM 248a of server 102a may be the same as the concept codes associated with the logical fields “Family Name” and “Given Name” of DAM 248b of server 102b. Accordingly, the query manager 244b of server 102b may be configured to generate the following local abstract query upon receiving the abstract query 510 provided above:
SELECT Given Name
WHERE Family Name=“Smith”

Local abstract queries may be similarly generated at each of the servers 102 receiving the abstract query 510 to retrieve results. The results may then be transferred to the server 102a via the network 190. Upon receiving the query results from the server 102a and one or more other servers 102b-d, query program 244a of server 102 may provide the results to a requesting client computer 101 or application 240.

In one embodiment of the invention, providing the results to a requesting client computer or application may involve performing a union operation to combine results received from each server 102a-d. However, any other reasonable method of integrating results received from multiple sources, for example, concatenation, may be also used. In alternative embodiments, the results from each source may be provided separately, for example, in separate files, or separated within a given results file. In one embodiment, the results from each of the servers 102 may be displayed in a GUI screen at the client computer 101.

In one embodiment of the invention, one or more servers 102 may receive the query 510, but may not have any results for the query. For example, server 102d may receive abstract query 510 described above, but may not have a logical field corresponding to the concept code of “Last Name”. Accordingly, the server 102d may be configured to respond to the server 102 with a “No result” or error message.

In one embodiment of the invention, the query manager 244a of server 102a may be configured to wait until results (or other response) are received from each of the one or more servers 102b-d before providing the query results to the requesting client computer 101 or application 240. In alternative embodiment, query manager 244a may wait for a predefined period of time to receive results. If the results are not received from all servers 102 within the predefined period of time, the query program 244a may be configured to provide only results received within the predefined period of time.

For purposes of illustration only, FIG. 5 shows the query 510 being sent from server 102a to each of the servers 102b-d. However, more generally, the query 510 may be sent from any server 102, to any one or more other servers 102 coupled to the P2P network 190. For example, each of the servers 102 of FIG. 5 may be configured to receive abstract queries from respective client computers 101 or application programs 240 and send the query to one or more other servers 102 as described above. Furthermore, in some embodiments the client computer 101 may be directly coupled with the P2P network 190 and configured to issue a query 510 to one or more servers 102. Accordingly, in some embodiments, the client computer 101 may include similar components as the servers 102, for example, a data abstraction model, query manager, and the like.

Furthermore, while embodiments are described herein with respect to a client-server model, this model is merely used for purposes of illustration. Persons skilled in the art will recognize other communication paradigms, all of which are contemplated as embodiments of the present invention. Indeed, as pointed out above, the server computers 102 may in fact be related as peers, rather than computers of in a client-server paradigm. Further, even assuming a client-server model, a given computer may behave as either a client or a server at different times, depending on the context. As such, the terms “client” and “server” are not to be taken as limiting.

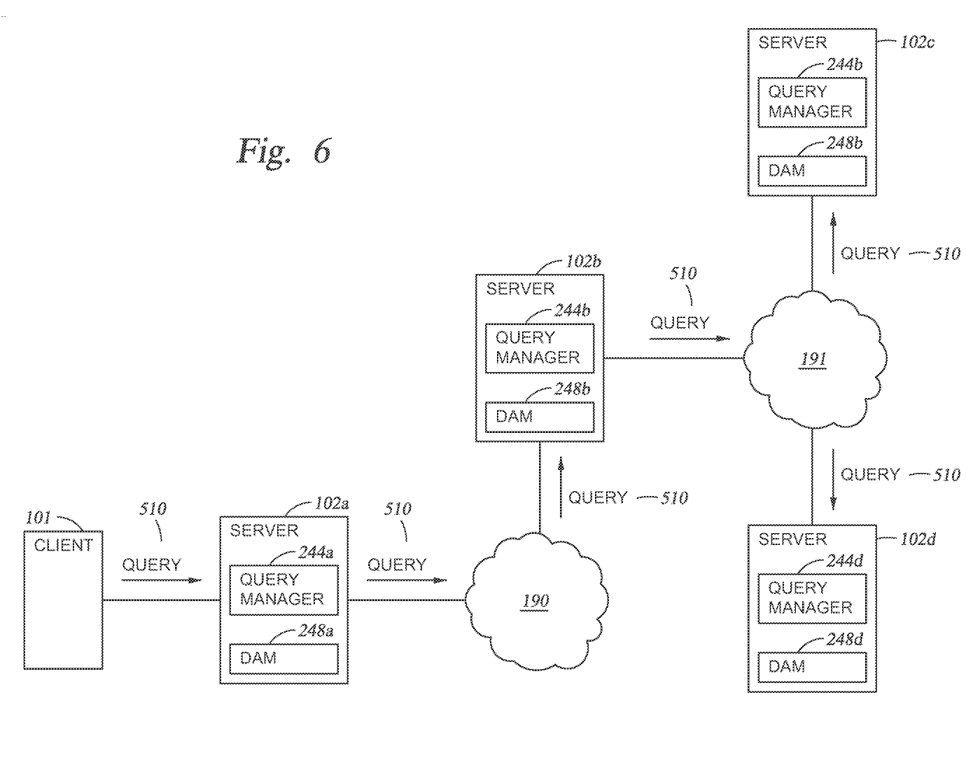

FIG. 6 illustrates another system 600 according to an embodiment of the invention. System 600 may include at least one client computer 101 and a plurality of servers 102, as illustrated in FIG. 6. As illustrated, the client computer 101 may be coupled with a server 102a. The server 102a may be coupled with a server 102b via a first P2P network 190, and server 102b may be coupled to the servers 102c and 102d via a second P2P network 191.

As illustrated in FIG. 6, an abstract query 510 may be sent from the client computer 510 to the server 102a. Server 102a may send the abstract query to server 102b via the network 190, as discussed above. The server 102b may retrieve results for the abstract query 510, for example, by converting the abstract query 510 to a local query, as discussed above. In addition, the query program 244b of the server 102b may transfer the query 510 to one or more other peers 102c and 102d via the P2P network 191 to retrieve further results for the query 510. For example, server 102b may include a record including a list of peer servers associated with the server 102b. Accordingly, query program 244b may access the record to determine its peer servers, and send the abstract query 510 to one or more of the peers listed in the record.

The server 102b may receive the results from the servers 102c and 102d via network 191, and combine the results with results from the server 102b before sending the results to the server 102a via the network 190. In an alternative embodiment, the server 102b may transfer its own results to the server 102a via network 190, and then subsequently transfer the results from servers 102c and 102d to the server 102a as they are received.

In some embodiments, each of servers 102c and 102d may be coupled with one or more other networks not shown in FIG. 6. Accordingly, the servers 102c and 102d may continue to send the query 510 to respective peers via the one or more other networks such that the query 510 cascades through multiple networks and multiple servers 102 to retrieve a comprehensive and complete set of results for the query 510.

The transfer of an abstract query from one server 102 to one or more other servers 102 over a network, for example, networks 190 and 191, is referred to herein as a “network hop”. In one embodiment of the invention, a server 102 or client 101 initiating transfer of an abstract query 510 to one or more other servers 102 may be configured to define a maximum network hops for the abstract query. For example, if the maximum hop for the query is set to 1, the abstract query 510 may only be sent from the server 102a to the server 102b via the network 190 (i.e. one network hop), but may not be sent from the server 102b to the servers 102c and 102d.

In one embodiment, the abstract query 510 may include the maximum hop value encoded therein. Furthermore, the abstract query 510 may also include a current number of hops encoded therein. Each server 102 may be configured to update the current hop value encoded in the abstract query 510 before sending the abstract query 510 to one or more other servers 102 via a P2P network. If a server 102 receives an abstract query 510 wherein the maximum hop value is equal to the current hop value, the server 102 may not send the query to any further servers 102.

In some embodiments, a server 102 may be coupled with multiple P2P networks. Therefore, it is possible that the server 102 may receive the same query 510 from each of the multiple P2P networks. However, providing query results each time the abstract query is received may result in a requesting client computer 101 or server 102 receiving duplicate copies of the query results. Therefore, in one embodiment of the invention, the query 510 may include a unique query ID encoded therein. Therefore, if a server 102 receives an abstract query having the same query ID as a previously received abstract query, the server 102 may simply ignore the abstract query or explicitly signal to the sending server that no action will be taken.

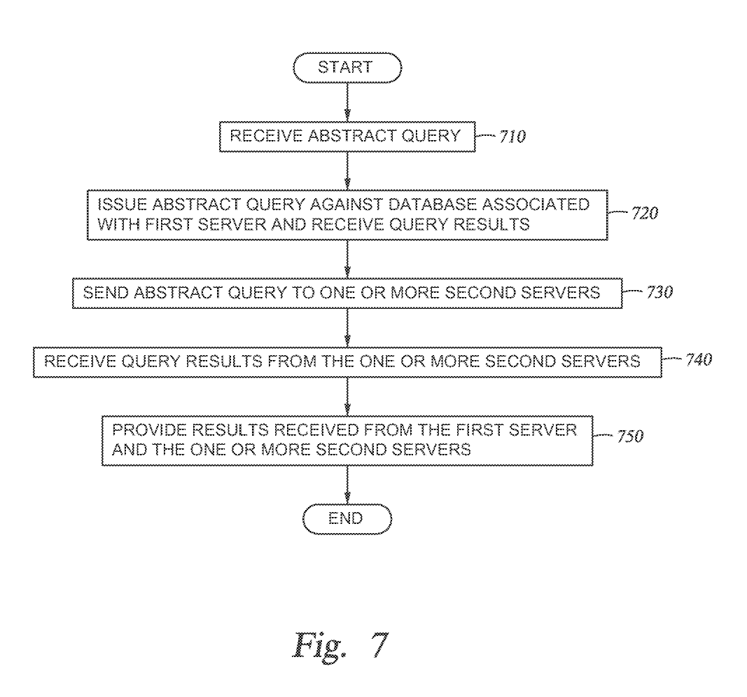

FIG. 7 is a flow diagram of exemplary operations performed by a query manager 244 according to an embodiment of the invention. The operations may begin in step 710 by receiving an abstract query. The abstract query may be received from a client computer 101 or an application 240 of a first server 102. Furthermore, the received abstract query may contain logical fields defined according to a first data abstraction model associated with the first server 102.

In step 720 the query manager 244 may issue the abstract query against a database associated with the first server 102 and receive query results. In step 730, the query manager 244 may send the abstract query to one or more second servers 102 via a network. The query manager may then receive results from the abstract query from one or more of the second servers 102 via the network in step 740. In step 750, the query manager 244 may provide the results received from the first server and one or more second servers to the requesting client computer or application 240.

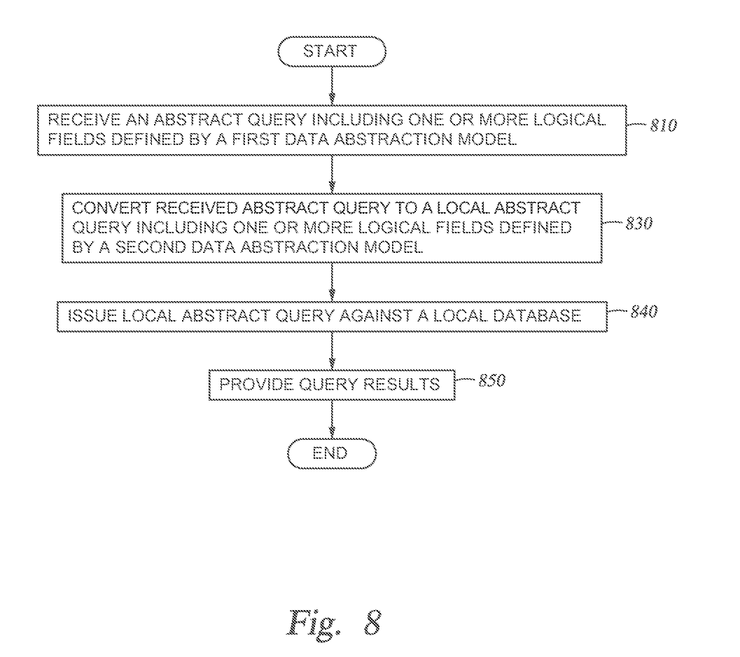

FIG. 8 is a flow diagram of exemplary operations performed by a query manager 244 according to another embodiment of the invention. The operations may begin in step 810 by receiving an abstract query including one or more logical fields defined by a first data abstraction model. In step 820, the query manager 244 may convert the received abstract query to a local abstract query including logical fields defined by a second data abstraction model.

Converting the received abstract query to a local abstract query may involve determining concept codes associated with each of the logical fields associated with the received abstract query. The concept codes may be, in one embodiment, received with the abstract query. The query manager 244 may identify logical fields in the second data abstraction model associated with the concept codes and generate the local abstract query based on the identified logical fields. In step 830, the query manager 244 may issue the local abstract query against a local database to retrieve query results. In step 840, the query manager may provide the query results to a requesting server 102 or client 101.

### P2P Data Licensing Model

In some embodiments, peer computers in a P2P environment may be configured to exchange data based on a licensing agreement to share the data. For example, a licensing agreement may allow users of server 102a of FIG. 1 to access data stored in server 102b. Typically, the licensing agreements allow a first peer device to access all the data at a second peer device. Accordingly, a user of the first peer device may have to pay for access to all types of data available at the second peer device.

However, the user may only be interested in a specific subset of the data available at the second peer device, and may wish to attain a license to only access the desired subset of data at the second peer device. Embodiments of the invention allow licensing terms to be set for specific subsets of data at a peer device, thereby allowing licensors to access only desired subsets of data. By allowing peers to license only desired data sets, greater value may be provided to the peers, thereby resulting in greater monetary benefits.

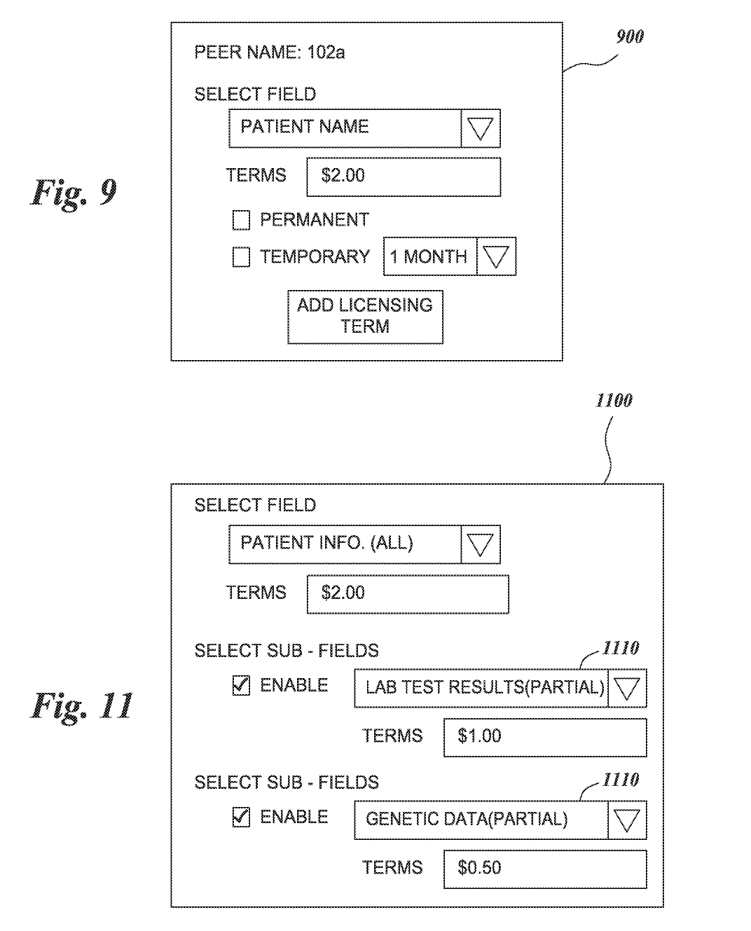

In one embodiment, a licensing program, e.g., the licensing program 245 illustrated in FIG. 2 may be configured to generate one or more GUI screens for defining licensing terms for access to data in a server. FIG. 9 illustrates an exemplary GUI screen 900 that may be generated by the licensing program 245, according to an embodiment of the invention. As illustrated in FIG. 9, the GUI screen 900 may be used to enter licensing terms for accessing data at a server 102a.

In one embodiment, the GUI screen may allow a user to select a field, table or other grouping of data for which a licensing term is to be added. The fields, tables, and other groupings of data may be selected from the fields of data available in a data abstraction model, e.g., the data abstraction model 248a of server 102a (see FIG. 5). FIG. 9 illustrates a field “PATIENT NAME” that has been selected using a drop down menu 910. The GUI 900 may also include graphical tools for entering one or more licensing terms. For example, a text box 920 is provided to enter a payment amount for accessing the field selected using the drop down menu 910.

Checkboxes 931 and 932 may be provided to enter a term for the license. For example, if check box 931 is selected a permanent license may be defined. However, if the checkbox 932 is selected a temporary license may be defined. In one embodiment, upon selecting the checkbox 932 a drop down menu 940 may be activated to select the licensing term. For example, a default term of one month is shown in the drop down menu 940 of FIG. 4. After making the appropriate selections a user may click the “Add Licensing Term” button 950 to apply the licensing term.

While the GUI screen 900 is shown comprising drop down menus, buttons, and check boxes, in alternative embodiments, any type and number of graphical tools may be used to define licensing terms. Furthermore, while licensing of only one field is illustrated in the GUI 900, in alternative embodiments, the GUI 900 may support licensing of a plurality of fields of data. Moreover, embodiments of the invention are not limited to the specific licensing terms illustrated in FIG. 9. In alternative embodiments, any type and number of licensing terms may be defined using a plurality of graphical tools in the GUI 900.

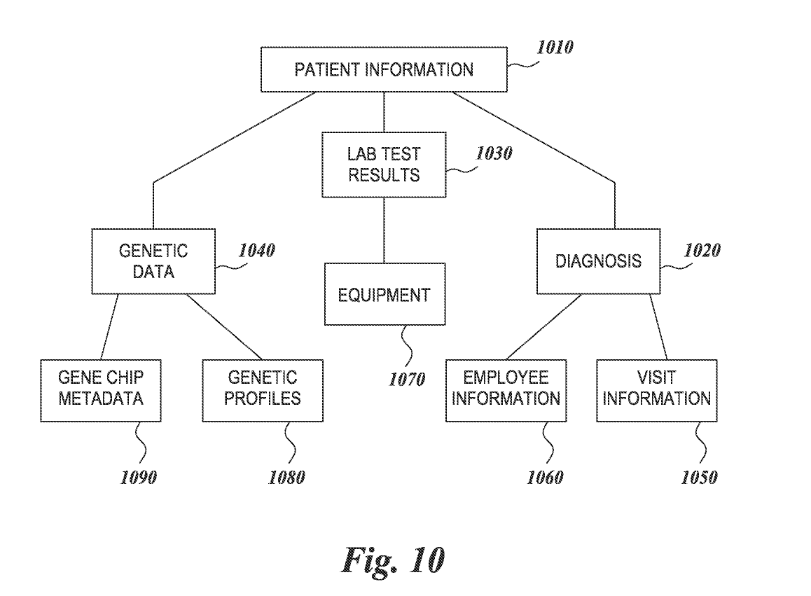

In one embodiment of the invention, data may be hierarchically arranged in a data abstraction model of a server, e.g., the server 102a of FIG. 5. For example, in one embodiment, the server 102a may be maintained by a medical organization. Therefore, the data abstraction model 248a at the server 102a may include fields and tables for data regarding its respective patients. FIG. 10 illustrates an exemplary hierarchical arrangement of data in the data abstraction model 248a according to an embodiment of the invention.

As illustrated in FIG. 10, the data abstraction model may include a patient information table 1010. The patient information table may include a diagnosis table 1020, a lab tests table 1030, and genetic data table 1040. Each of the a diagnosis table 1020, a lab tests table 1030, and genetic data table 1040 may include further sub-tables and/or fields, e.g., visit information 1050, employee information 1060, equipment 1070, genetic profiles 1080, and gene chip metadata 1090.

In one embodiment, the licensing program 245 may be configured to depict the hierarchical arrangement of data fields and tables in a data abstraction model. FIG. 11 illustrates another exemplary GUI screen 1100 according to an embodiment of the invention. As illustrated in FIG. 11, a Patient Information field is shown as a selected root data field. A plurality of sub-field selection drop down menus 1110 are illustrated. A user may be allowed to select a sub field of the Patient Information field and specify licensing terms for the sub-field. For example, sub fields Lab Test Results, and Genetic Data are shown selected, along with respective licensing terms. The Lab Test Results and Genetic Data fields may include a subset of the data included in the Patient Information field. Accordingly, licensing the sub fields may result in licensing a subset of the data. As illustrated in FIG. 11, enable checkboxes 1120 are also provided to allow enablement of the licensing terms of the sub-fields.

In one embodiment, sub fields of a root field may have a predefined relationship to each other. For example, referring to FIG. 10, diagnosis data in the Diagnosis field 1020 may be based on lab test results data in the Lab Test Results field 1030. If a licensor only licenses the Diagnosis field 1020, then diagnosis data may be displayed to the licensor in response to a query. However, lab test results data related to the diagnosis data may not be displayed. If a query issued by the licensor requests lab test result data associated with the diagnosis data, the licensor may be provided an indication that the lab test result data is available for licensing, as described below.

In one embodiment, if a licensing term is selected for a root field, then licensing terms may not be specified for specific root data fields. This may be because the data in the sub-fields may be available via the license terms of the root field. In alternative embodiments, licensing terms may be specified for one or more of the root field and its respective sub-fields.

While one root field and two sub-fields are shown in FIG. 11, in alternative embodiments, any number of root fields and any number of sub-fields may be displayed in the GUI 1100. Furthermore, each sub-fields may have its own respective sub-fields. In some embodiments, one or more root fields or sub fields may be collapsible or expandable to hide or reveal its respective sub-fields.

In one embodiment, upon applying the licensing terms using the GUIs described above, the licensing program 245 may be configured to ensure that a licensed data field is disclosed only to peers that have acquired a valid license. For example, in some embodiments, upon receiving a query directed to a licensed field, the licensing program 245 may be configured to respond to the query, such that the requesting entity is notified about the licensing terms to access the field prior to displaying the data from the licensed field.

For example, upon receiving a query, a server may be configured to retrieve results for the query using the methods described in the previous section. In one embodiment, once the query results are retrieved, the licensing program 245 may be configured to determine whether a requesting entity, e.g. a peer server or client, has an appropriate license to access the results. If the requesting entity does not have the appropriate license to access one or more fields in the results, the licensing program 245 may be configured to conceal the unlicensed data.

For example, in one embodiment, the licensing program 245 may encrypt the data in one or more unlicensed fields. Therefore, the data in the unlicensed fields may not be visible to the requesting entity without first acquiring a license. In one embodiment, the licensing program may be configured to prompt the requesting entity to license encrypted or otherwise concealed data, in order to view the full results of the query.

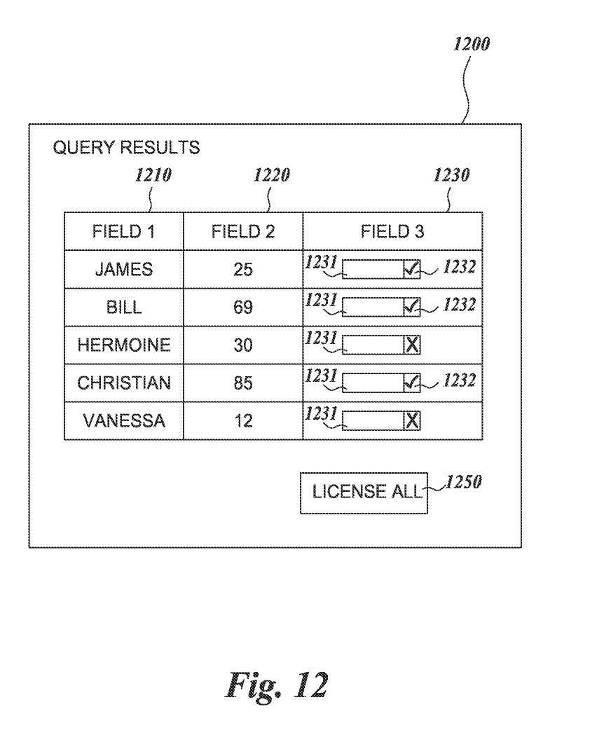

FIG. 12 illustrates an exemplary GUI screen 1200 that may be generated by a query manager, according to an embodiment of the invention. The GUI screen 1200 may be configured to display results of a query. As illustrated in FIG. 12, the results may include a plurality of data fields, e.g., the fields 1210-1230. As shown in Figure the fields 1210 and 1220 include data, however, the data in field 1230 is not shown. Instead, an indicator, e.g., boxes 1231, are shown to indicate that a license is required to view the data.

In one embodiment, the boxes 1231 may include a further graphical indication depicting whether the data may be licensed or not. For example, the check marks 1232 indicate that the data record in the field 1230 can be licensed. If the further graphical indication is not present, the data in the data record may not be available to be licensed, in some embodiments. Embodiments of the invention are not limited to the specific graphical indications illustrated herein. In alternative embodiments, any reasonable graphical tool may be used to visually indicate to a user that one or more data records or data fields may be viewed upon acquiring a license.

In one embodiment, upon selecting, e.g. clicking one or more of the boxes 1231, one or more GUI screens for licensing the clicked boxes 1231 may be displayed. The one or more GUI screens may display licensing terms and may prompt the user for payment, or a method of payment for viewing the data upon agreement to the licensing terms.

In one embodiment of the invention, one or more graphical tools may be provided to license all or a subset of one or more data records in a field that requires a license. For example, a license all button 1250 is shown in GUI 1200. Clicking the license all button 1250 may generate GUI screens that describe the terms and the cost of licensing all the hidden data in the query results. Upon accepting the licensing terms, the results in the hidden fields may be displayed to the user.

In one embodiment, the GUI screen 1200 may be displayed at an entity that requests results for an abstract query from a plurality of different peer devices. Because the entity may have different licensing agreements with different peers, in one embodiment, it is possible that any one of the fields 1210-1230 may include hidden or encrypted data. Accordingly in such embodiments, the GUI screen 1200 may include tools for selecting results from particular peers and licensing only the hidden results from the particular peers.

By allowing peer devices to selectively license only desired data sets from peer devices, embodiments of the invention allow peer devices to extract greater value from their respective relationships.

While the foregoing is directed to embodiments of the present invention, other and further embodiments of the invention may be devised without departing from the basic scope thereof, and the scope thereof is determined by the claims that follow.

What is claimed is:

1. A method for providing results for a query, comprising:
defining at least one licensing term for accessing at least a first field defined by a data abstraction model comprising a plurality of logical field definitions mapped to physical fields of a database;
receiving an abstract query from a requesting entity, wherein the abstract query comprises one or more logical fields defined by the data abstraction model, the one or more logical fields of the query comprising the first field;
retrieving results for the abstract query;
determining whether the requesting entity has acquired a license to access the first field based on the licensing term; and
upon determining that the requesting entity has not acquired a license to access the first field, providing the retrieved results to the requesting entity, wherein data in the first field is concealed from the requesting entity.

2. The method of claim 1, wherein defining the at least one licensing term for accessing at least a first field comprises:
providing a graphical user interface (GUI) screen for selecting at least one logical field of the plurality of logical definitions in the data abstraction model; and
providing at least one graphical tool for defining at least one licensing term for accessing a selected logical field.

3. The method of claim 1, wherein the plurality of logical definitions of the data abstraction model are hierarchically arranged, wherein the one or more logical fields of the query comprises a second field related to the first field in the hierarchy, the second field being licensed by the requesting entity, and wherein providing the retrieved results comprises displaying results retrieved from the second field.

4. The method of claim 1, wherein providing the retrieved results to the requesting entity comprises generating a GUI screen comprising the query results, wherein the GUI screen displays the first field, and wherein data in the first field is concealed.

5. The method of claim 1, further comprising providing, with the query results, at least one tool for requesting a license to view the data in the first field.

6. The method of claim 1, wherein the data in the first field is encrypted.

7. The method of claim 1, wherein the abstract query is received from the requesting entity via a peer to peer network.

8. A computer readable storage medium comprising a program product which, when executed, is configured to perform operations for providing results for a query, the operations comprising:
defining at least one licensing term for accessing at least a first field defined by a data abstraction model comprising a plurality of logical field definitions mapped to physical fields of a database;
receiving an abstract query from a requesting entity, wherein the abstract query comprises one or more logical fields defined by the data abstraction model, the one or more logical fields of the query comprising the first field;
retrieving results for the abstract query;
determining whether the requesting entity has acquired a license to access the first field based on the licensing term; and
upon determining that the requesting entity has not acquired a license to access the first field, providing the retrieved results to the requesting entity, wherein data in the first field is concealed from the requesting entity.

9. The computer readable storage medium of claim 8, wherein defining the at least one licensing term for accessing at least a first field comprises:
providing a graphical user interface (GUI) screen for selecting at least one logical field of the plurality of logical definitions in the data abstraction model; and
providing at least one graphical tool for defining at least one licensing term for accessing a selected logical field.

10. The computer readable storage medium of claim 8, wherein the plurality of logical definitions of the data abstraction model are hierarchically arranged, wherein the one or more logical fields of the query comprises a second field related to the first field in the hierarchy, the second field being licensed by the requesting entity, and wherein providing the retrieved results comprises displaying results retrieved from the second field.

11. The computer readable storage medium of claim 8, wherein providing the retrieved results to the requesting entity comprises generating a GUI screen comprising the query results, wherein the GUI screen displays the first field, and wherein data in the first field is concealed.

12. The computer readable storage medium of claim 8, further comprising providing, with the query results, at least one tool for requesting a license to view the data in the first field.

13. The computer readable storage medium of claim 8, wherein the data in the first field is encrypted.

14. A system, comprising:
at least a first device and a second device, wherein the first device comprises a data abstraction model comprising a plurality of logical field definitions mapped to physical fields of a database, wherein the first device is configured to:
define at least one licensing term for accessing at least a first field defined by the data abstraction model;
receive an abstract query from the second device, wherein the abstract query comprises one or more logical fields defined by the data abstraction model, the one or more logical fields of the query comprising the first field;
retrieve results for the abstract query;
determine whether the requesting entity has acquired a license to access the first field based on the licensing term; and
upon determining that the requesting entity has not acquired a license to access the first field, provide the retrieved results to the requesting entity, wherein data in the first field is concealed from the requesting entity.

15. The system of claim 14, wherein, to define the at least one licensing term for accessing at least a first field, the first device is configured to:
provide a graphical user interface (GUI) screen for selecting at least one logical field of the plurality of logical definitions in the data abstraction model; and
provide at least one graphical tool for defining at least one licensing term for accessing a selected logical field.

16. The system of claim 14, wherein the plurality of logical definitions of the data abstraction model are hierarchically arranged, wherein the one or more logical fields of the query comprises a second field related to the first field in the hierarchy, the second field being licensed by the requesting entity, and wherein providing the retrieved results comprises displaying results retrieved from the second field.

17. The system of claim 14, wherein the first device is configured to provide the retrieved results to the second device by generating a GUI screen comprising the query results, wherein the GUI screen displays the first field, and wherein data in the first field is concealed.

18. The system of claim 14, wherein the first device is further configured to provide, with the query results, at least one tool for requesting a license to view the data in the first field.

19. The system of claim 14, wherein the first device is configured to encrypt data in the first field.

20. The system of claim 14, wherein the first device and the second device are connected to a peer to peer network.
